(19) United States
(12) Patent Application Publication
(10) Pub. No.: US 2010/0085649 A1
(43) Pub. Date: Apr. 8, 2010

(54) Optical objective module

(75) Inventors: Wladimir Wischnewskij, Waldbronn (DE); Oleksiy Vyshnewskyy, Worth (DE)

Correspondence Address: BODNER & O'ROURKE, LLP, 425 BROADHOLLOW ROAD, SUITE 108, MELVILLE, NY, 11747, US

(73) Assignee: PHYSIK INSTRUMENTE (PI) GMBH & CO. KG, Karlsruhe (DE)

(21) Appl. No.: 11/919,097

(22) PCT Filed: Feb. 17, 2006
(86) PCT No.: PCT/EP2006/001474

§ 371 Date: Oct. 22, 2009

(30) Foreign Application Priority Data
Aug. 19, 2005 (DE) 10 2005 039 357.8

(51) Int. Cl. G02B 7/09; G02B 7/10

(52) U.S. Cl. 359/698; 359/696

(57) ABSTRACT

The invention relates to an objective module comprising an optical zoom lens group (2) and a focusing optical lens group (4), the combined optical axes forming the optical axis (7) of the objective, and an electrical drive for the two lens groups. According to the invention, the electrical drive of the cited lens groups is embodied in the form of two linear ultrasonic motors (9, 11), each of the two ultrasonic motors consisting of a piezoelectric plate (12) comprising two friction elements (14) which are pressed against the opposing front sides and form the mobile elements of the ultrasonic motors together with the pressure elements (15). Each of the mobile elements is elastically connected to the corresponding lens group. The ultrasonic motors are arranged in such a way that the direction of displacement of the mobile elements is parallel to the optical axis of the optical module.

The invention relates to an optical objective module comprising an integrated ultrasonic drive according to the preamble of patent claim 1. Such objective modules may be used in miniaturized, high-precision photographic or video cameras. The invention can moreover be used in inexpensive miniaturized consumer electronic devices, in which such cameras are employed. This includes, inter alia, pocket computers, dictating machines and mobile phones.

Known is the embodiment of optical objectives as individually constructed units, in the interior of which optical lenses and rotational ultrasonic motors as drive are mounted, said rotational ultrasonic motors being disposed on the same axis as the lenses and displacing the lenses (see DE 36 26 389 A1). In these objectives ultrasonic traveling wave motors with a relatively large stator diameter are used.

These ultrasonic motors have a complex structure, are labor-intensive and expensive to manufacture and can, moreover, not be miniaturized. For this reason, such objective units are exclusively employed in large and, moreover, expensive apparatus.

Further known are optical objectives with smaller diameter ultrasonic motors not disposed on the same axis (see EP 0 469 883 A2). In these objectives cylindrical standing wave type ultrasonic motors are used. The transmission of motion from the motor axle to the lens group to be moved is achieved by a high-ratio gear set. The objective of the type Ultrasonic EF35-80 mm f/4-5,6 manufactured by the company Canon in various modifications is one example for a series product of such an objective unit.

One drawback of these objectives resides in the complicated architecture of the ultrasonic motor and the high production costs for the whole apparatus incurred thereby. Moreover, objectives including such motors have large sizes because it is practically impossible to produce ultrasonic motors with dimensions of less than 10 mm. Furthermore, because of the use of toothed gearings, the focusing accuracy of these objectives is too small, they take too much time for the focusing and cause operating noises during the focusing.

Additionally known is the use of miniaturized objective units, in which miniaturized rotational ultrasonic motors having ultrasonic resonators adhesive-bonded thereto are employed (see in this respect “PIEZOELECTRIC ULTRASONIC MICROMOTORS FOR MECHATRONIC APPLICATIONS, International Center for Actuators and Transducers, The Pennsylvania State University, PA 16802, USA). These modules have two separate optical lens groups each being driven by a separate ultrasonic motor via a spindle.

A disadvantage of these objective units is their complicated construction of the drive, which consists of a multitude of high-precision components the production of which requires an expensive precision technology. This renders the objective unit more expensive and prevents their use in inexpensive consumer electronic devices. The use of a spindle requires longer periods for the focusing. Moreover, the accuracy of the focusing is clearly reduced. An inexact focusing deteriorates the image quality.

It is the object of the invention to provide a generic objective (optical module), wherein the construction is simplified, the focusing accuracy is increased, the time for the adjusting process is shortened and the production costs as well as the noise level are reduced.

The above object is achieved with an apparatus comprising the features of claim 1.

Advantageous embodiments of the inventive idea are defined in the dependent claims.

The invention includes the idea to realize the production of a miniaturized optical module which allows a coaxial adjustment of two groups of optical lenses with the aid of two ultrasonic linear motors controlled by an electronic control unit, wherein the occurring deviation of the optical axes of each of the lens groups from the optical axis of the entire optical module is kept at a minimum.

In the preferred miniaturized optical module, which includes an optical zoom lens group and a focusing optical lens group, whereof the coinciding optical axes form the optical axis of the optical module, the electric drive of the aforementioned optical lens groups comprises electronic control units with associated inputs for the photoelectric imaging sensor to convert the image into an electric drive signal of the aforementioned optical lens group. It is embodied in the form of two ultrasonic linear motors, whereof each is realized in the form of a piezoelectric plate having two friction elements which are pressed against the opposite front sides and form the mobile elements of the ultrasonic motor together with the press-on elements, wherein each of the mobile elements is elastically connected to the corresponding optical lens group, wherein the ultrasonic motors are arranged in such a way that the direction of motion of the mobile elements extends in parallel to the optical axis of the optical module.

This allows a simple constructive architecture for the optical module, a greater focusing accuracy, shorter focusing times, lower production costs and reduced operating noise.

In some modifications of the proposed embodiment of the optical module the front sides of the piezoelectric plates may be realized as guiding grooves, which fix the mobile elements in such a way that the optical axes of the aforementioned optical lens groups are in coincidence upon their displacement within the focal range of the optical module.

This allows a uniformly high resolution of the optical module over the entire focal length.

In other modifications of the optical module the front sides of the piezoelectric plates may moreover be realized as flat surfaces, and each of the optical lens groups may comprise one or two guiding elements fixing each of the optical lens groups in such a way that the optical axes are in coincidence upon their displacement within the focal range of the optical module.

This allows a reduction of the production expenditure for the ultrasonic motors, which also reduces the costs for the optical modules provided with such ultrasonic motors.

In the optical module according to the proposed embodiment the ultrasonic motors may be mounted on diametrically opposite sides of the optical axis of the module.

Moreover, the ultrasonic motors may be mounted on one side of the optical axis of the module.

Both modifications extend the constructive possibilities for the module as proposed.

In all modifications of the proposed embodiment for an optical module the electronic control unit may consist of two self-exciting generators for the independent and simultaneous excitation of the ultrasonic motors. The generated frequency of each of the self-excited generators is thereby predetermined by the working resonance frequency of the motor connected to the same. Each of the self-exciting generators may be provided with both a power amplifier and a feedback element with a feedback circuit and a switch for changing the direction of the mobile parts.

If appropriate, the electronic control unit can also comprise only one self-excited generator for the alternate independent excitation of the two motors connected to it, which may be provided with a power amplifier, a feedback element with a feedback circuit as well as with a switch for changing the direction of the mobile parts.

This allows the simplification of the electronic control unit and, thus, a more cost-efficient production.

In the self-exciting generators of the electronic control units the switch for changing directions may be embodied as a two-pole switch, wherein one pole is connected to the corresponding excitation electrode of the respective ultrasonic motor and the other one is connected via a feedback element and a power switch of a power amplifier to the common motor electrode, wherein the control input of the power switch is connected via the feedback loop to the feedback element, namely at the point where it is connected to the pole of the switch for changing directions.

This allows a simplification of the electric circuit of the self-exciting generator.

In various modifications of the proposed structure for an optical module at least one optical lens group may be coupled mechanically to its position sensor, the output of which is connected to the electronic control unit.

This allows to increase the positioning accuracy of this optical lens group.

The position sensor for the optical lens group may be embodied as a linear potentiometer, wherein the potentiometer arm is mechanically connected to the mobile motor element or to the optical lens group.

This simplifies the constructive embodiment of the optical module.

Moreover, the position sensor for the optical lens group may be embodied as a semiconductor tensosensor coupled to the elastic displacement-force converter, which is, again, mechanically connected to the mobile motor element or to an optical lens group.

This augments the positioning accuracy of the optical lens group.

In some modifications of the module as proposed the electronic control unit may comprise a computing unit for the relative position determination of the optical lens groups, which is connected to the position sensor of the optical lens groups and the information outputs of which are connected to the control inputs of one or both self-exciting generators.

This simplifies the control algorithm.

For positioning the optical lens groups the electronic control unit may include a digital control unit with a zoom input and a focus input, the outputs of which are connected to the control inputs of one or both self-exciting generators.

This expands the functional use capabilities of the optical module.

Advantageous embodiments and aspects of the present invention are shown in the following description of preferred embodiments by means of the figures. In the figures:

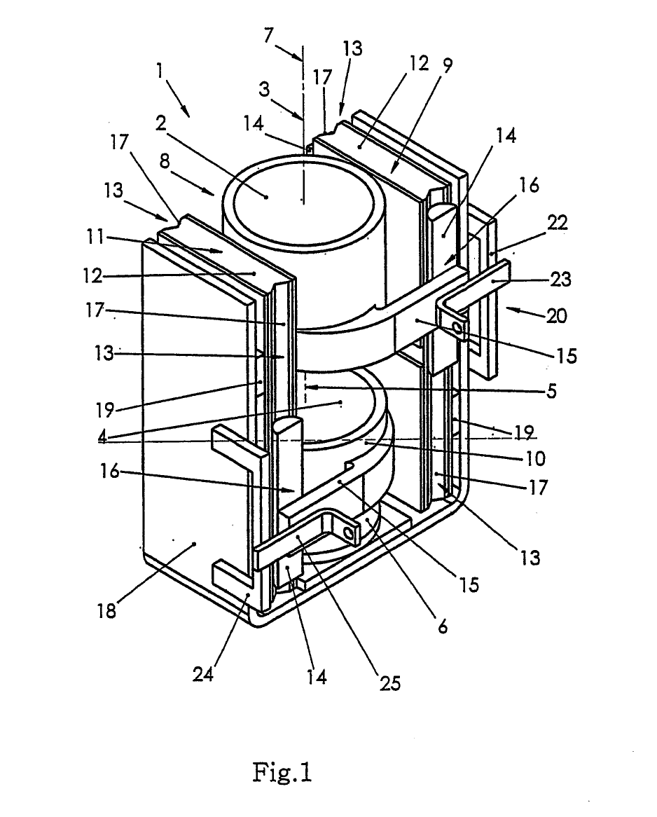

FIG. 1 shows an optical module with ultrasonic motors mounted on two sides;

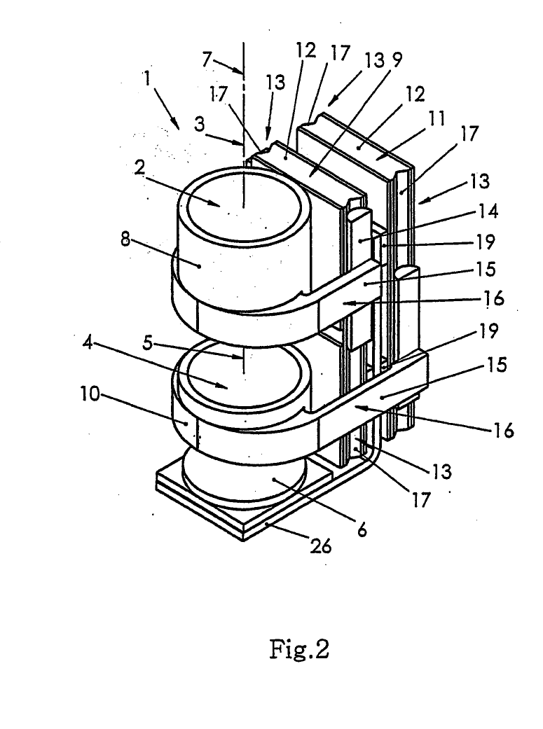

FIG. 2 shows an optical module with ultrasonic motors mounted on one side;

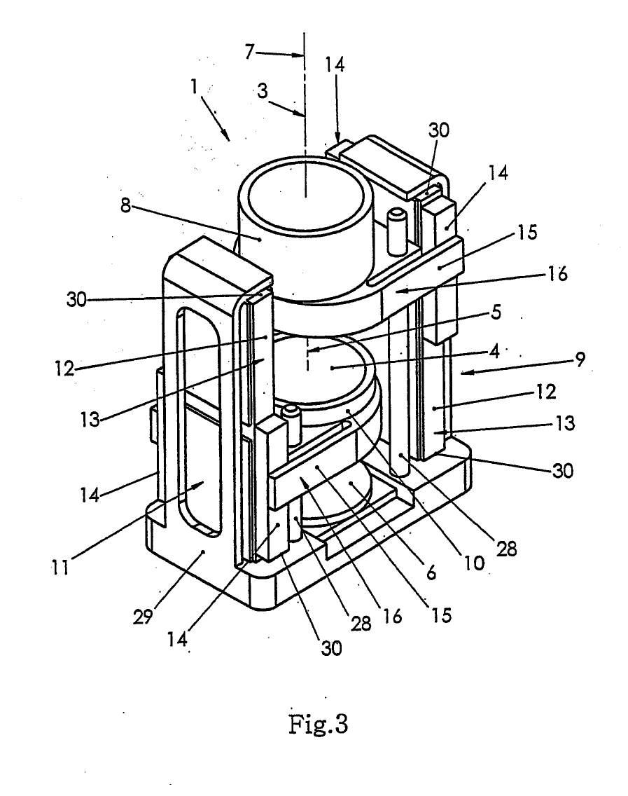

FIG. 3 shows an optical module with guides;

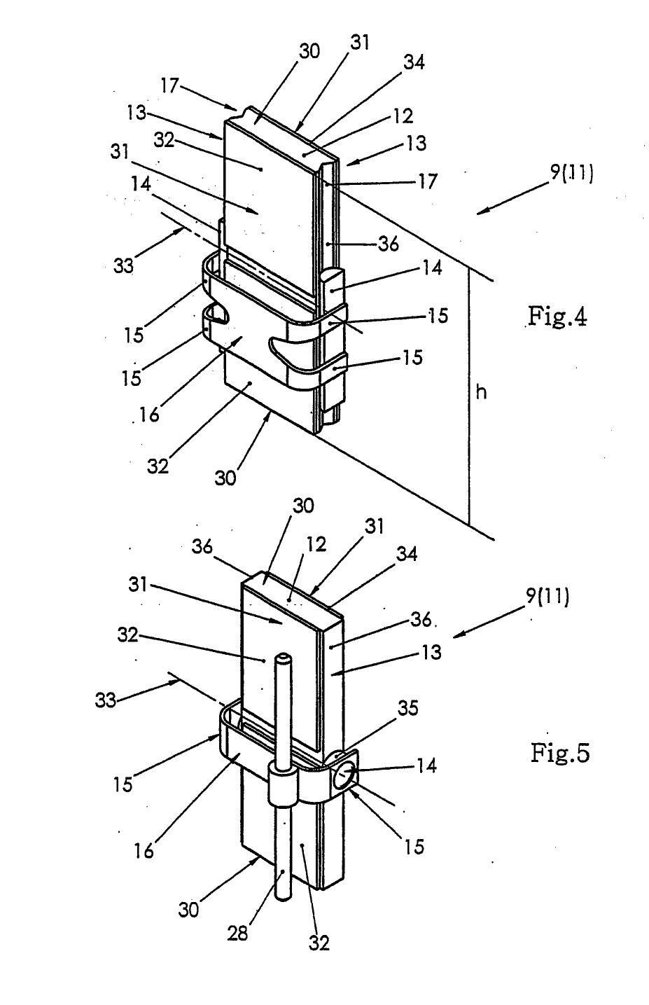

FIG. 4 shows an embodiment of the ultrasonic motor 9;

FIG. 5 shows an embodiment of the ultrasonic motor 10;

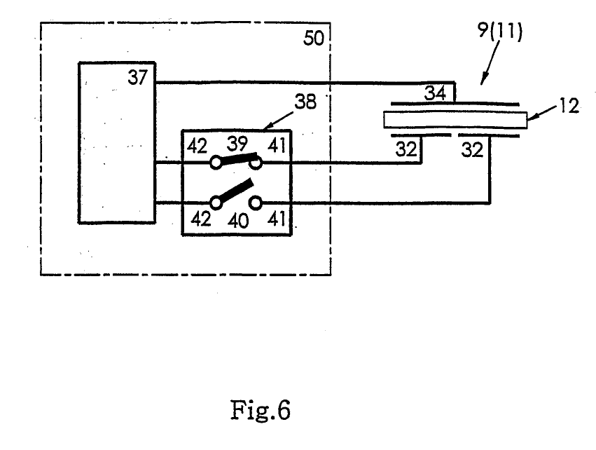

FIG. 6 shows a connection diagram of the ultrasonic motor with an excitation source;

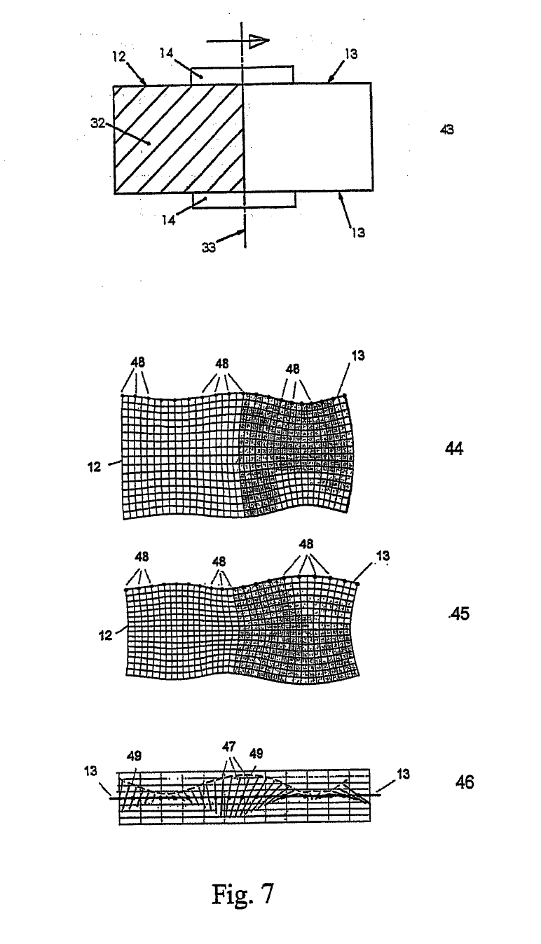

FIG. 7 shows illustrations for explaining the functional principle of the ultrasonic motor;

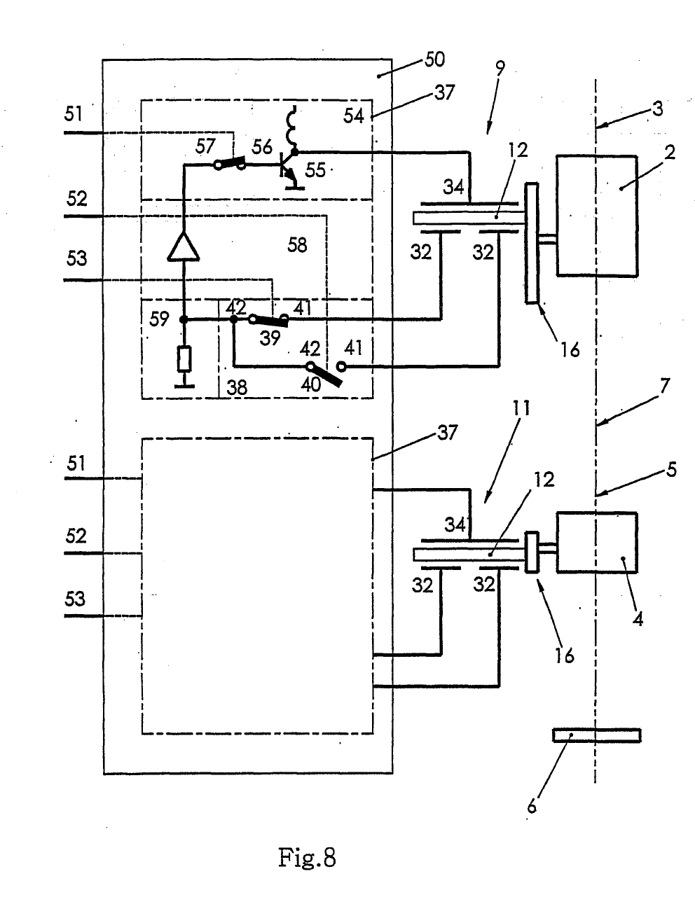

FIG. 8 shows an embodiment for an electric circuit of the optical module 1;

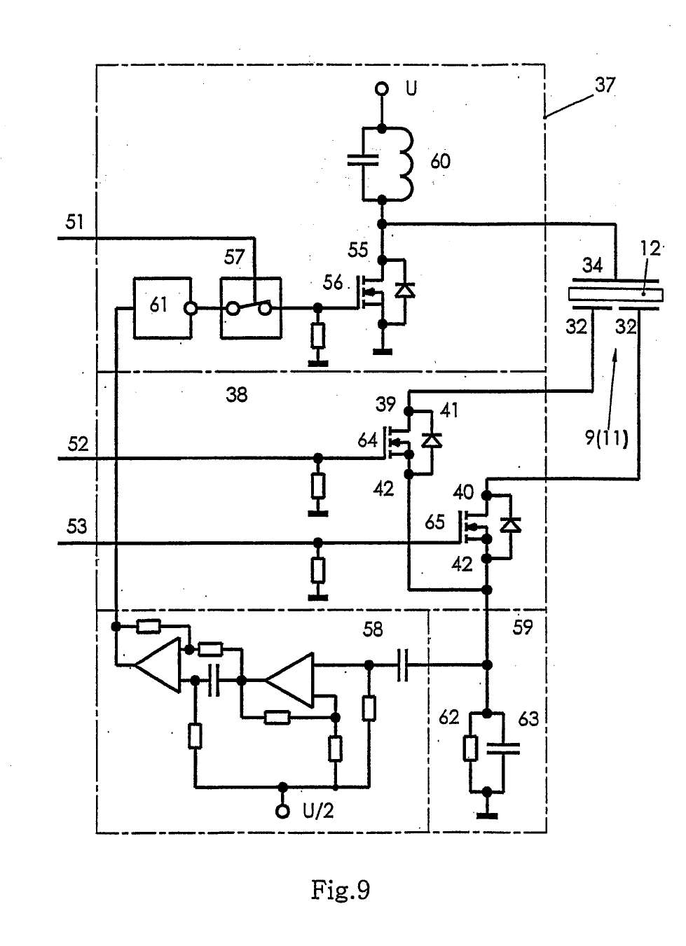

FIG. 9 shows an embodiment for an electric circuit of the self-exciting generator 36;

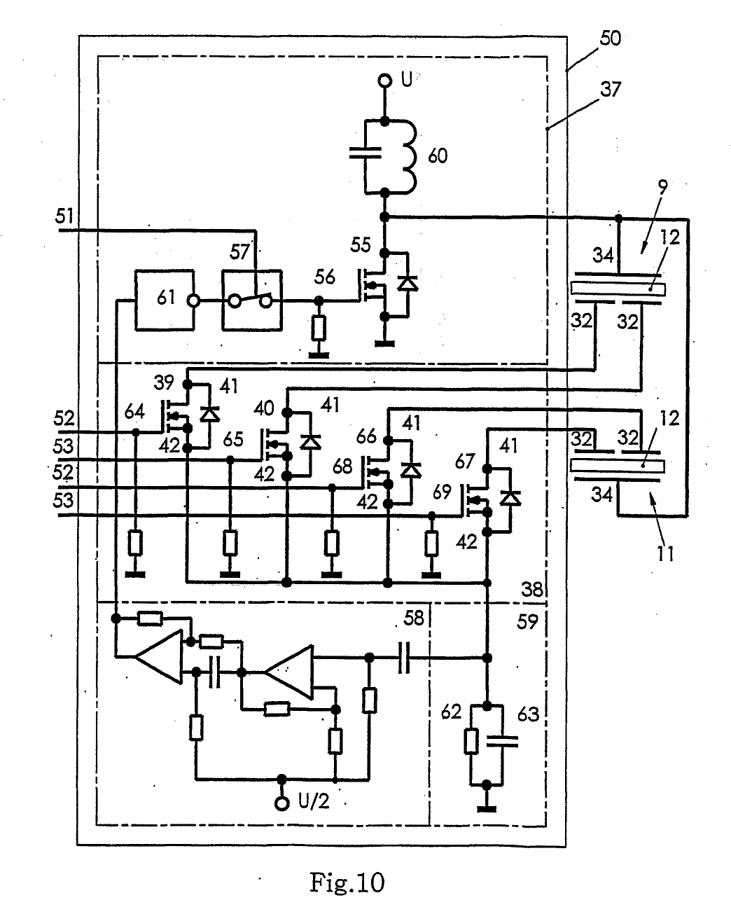

FIG. 10 shows an electric circuit diagram of the electronic control unit 50 with a self-exciting generator 36;

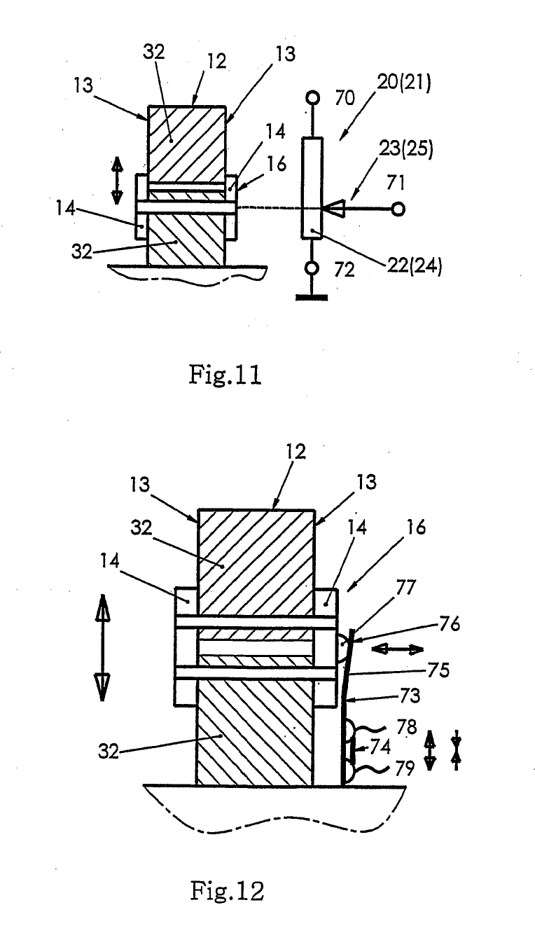

FIG. 11 shows an embodiment of a position sensor;

FIG. 12 shows an embodiment of a position sensor;

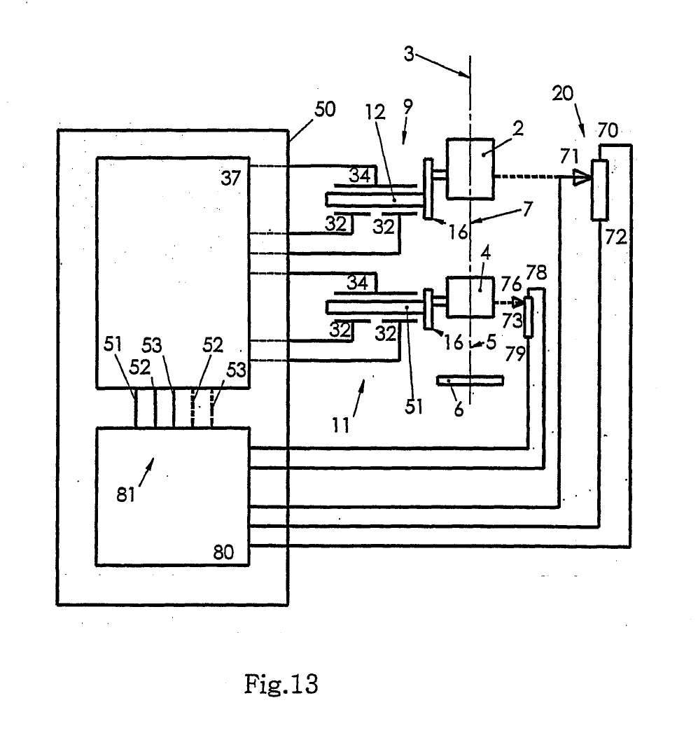

FIG. 13 shows an embodiment of the electric circuit of the optical module 1 comprising a computing unit 80 for the relative position determination of the optical lens groups 2, 4;

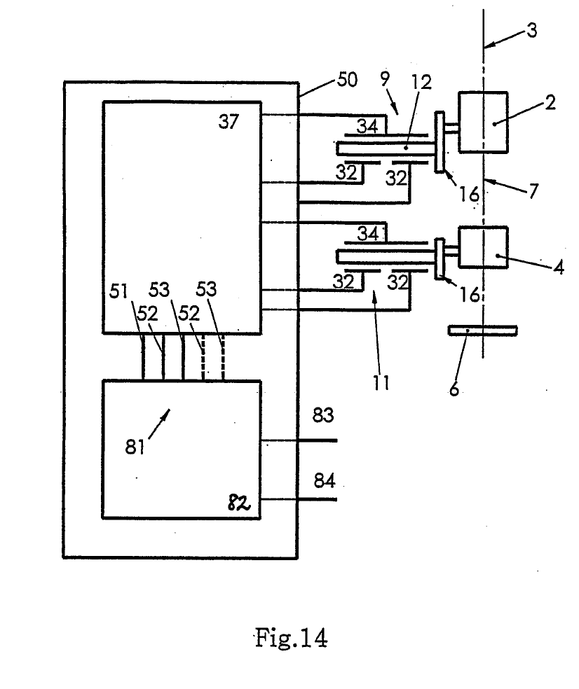

FIG. 14 shows the electrical control unit 50 with a digital control unit 82;

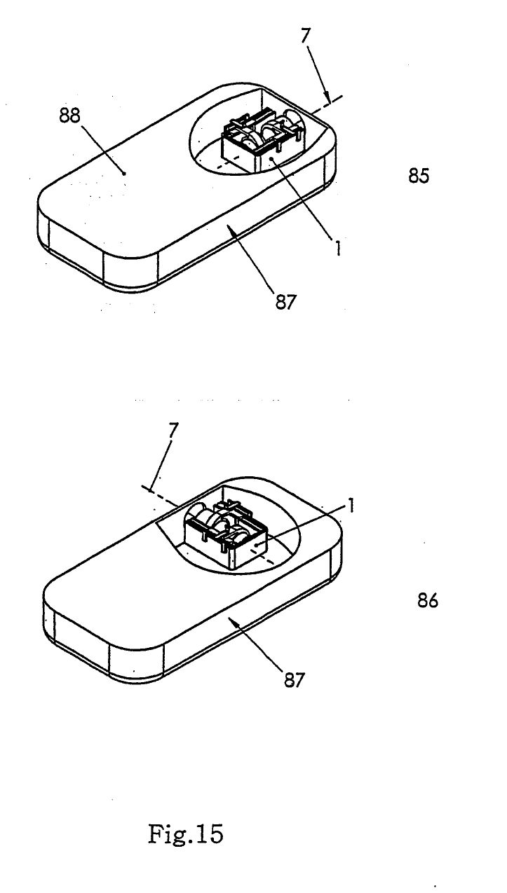

FIG. 15 shows embodiments of the arrangement of the optical module 1 in apparatus casings.

The optical miniature module 1 (FIG. 1) is comprised of a zoom lens group 2 with the optical axis 3 thereof, a focusing optical lens group 4 with the optical axis 5 thereof as well as a photoelectric imaging sensor 6. The two optical lens groups 2, 4 are arranged in such a way that their optical axes 3 and 5 coincide and form together the optical axis 7 of the optical module 1.

The optical lens group 2 is mechanically connected by a carrier 8 to a first ultrasonic motor 9. The optical lens group 4 is mechanically connected by a carrier 10 to a second ultrasonic motor 11.

The two ultrasonic motors 9, 11 form together the drive for the optical module 1.

Both ultrasonic motors 9 and 11 consist of a piezoelectric plate 12 with friction elements 14 pressed against the opposite lateral surfaces 13. Elastic press-on elements 15 pressing the friction elements 14 against the lateral surfaces 13 form part of the carriers 8, 10. The friction elements 14 form together with the press-on elements 15 mobile elements 16 of the ultrasonic motors 9, 11.

Each of the lateral surfaces 13 of the piezoelectric plate 12 may be provided with guiding grooves 17 in which the friction elements 14 are mounted. The piezoelectric plates 12 are fixed by means of the sound-absorbing back-ups 19 in a U-shaped casing 18 to ensure the movement direction of the mobile elements 16 of the ultrasonic motors 9, 11 parallel to the optical axis 7 of the optical module 1. In the optical module 1 illustrated in FIG. 1 the ultrasonic motors 9, 11 are arranged on diametrically opposite sides with respect to the optical axis 7 of the optical module 1.

Each of the lens groups 2, 4 may include a position sensor 20 or 21, respectively, which are assigned to the photoelectric imaging sensor 6. Each of the position sensors 20 and 21 includes a stationary part 22 and 24, respectively, as well as a mobile part 23 and 25, respectively.

FIG. 2 shows an embodiment of the optical module 1, in which the ultrasonic motors 9 and 11 are disposed in an L-shaped casing 26 in such a way that they are both located on the same side of the optical axis of the module 1.

FIG. 3 shows an embodiment of the optical module 1, in which the lateral surfaces 13 of the piezoelectric plates 12 are embodied as flat surfaces 27. In this embodiment, the optical module 1 is provided with additional guide rods 28. In this modification, the piezoelectric plates 12 are retained by the sound-absorbing casing 29 through their front sides 30. For absorbing sound the casing is made of a synthetic material having a low mechanical quality.

FIGS. 4 and 5 show two further modified embodiments of ultrasonic motors comprising the optical module 1 according to the invention, wherein each of the ultrasonic motors is made of a piezoelectric ceramic or a piezoelectric crystal.

In both modifications as illustrated two rectangular excitation electrodes 32, are mounted on one of the larger sides 31 of the plate 12. The electrodes 32 are mounted on side 31 symmetrically with respect to the longitudinally extending axis of symmetry 33. On the second larger side of the plate 12 a continuous common electrode 34 is mounted. Another arrangement of the excitation electrodes 32 and the common electrode 34 is possible as well. For example, the piezoelectric plate 12 may be embodied in a multi-layer structure, wherein the excitation electrodes and the common electrode are disposed reciprocally (not illustrated in the drawing).

The friction elements 14 are pressed against the lateral surfaces 13 of plates 12. In the motor shown in FIG. 4 the lateral surfaces 13 are embodied as guiding grooves 17 in which the friction elements 14 are disposed. The guiding grooves 17 may have a rounded, a triangular or any other desired shape. FIG. 5 shows a motor in which the side face 13 is embodied as a flat surface 27.

The friction elements 14 may be embodied as cylindrical rods (not shown in the drawing), semi-cylindrical rods (FIGS. 1, 2, 4), rectangular rods (FIG. 3), triangular rods (not shown in the drawing) or also as hemispheres 35 (FIG. 5). As material for the production of the friction elements 14 steel, oxide ceramics, metal ceramics or a hard abrasion-resistant synthetic material may be used.

In each of the ultrasonic motors 9 and 11 the surface of the piezoelectric plate 12, which is in contact with the friction element 14, is embodied as a friction surface 36 (FIGS. 4, 5), which ensures the frictional contact between the plate 12 and the friction element 14. Also the surface of piezoelectric ceramic or of the piezoelectric crystal alone may serve as friction surface 36. In addition, an abrasion-resistant layer in the form of a thin coating of an abrasion-resistant material such as Ti, Cr, TiN, TiCN, CrN, TiAlN, ZrN, TiZrN, TiCrN or also of another suitable material can be applied onto the piezoceramic plate 12 being in contact with the friction element 14, the surface of said coating forming, in this case, the friction surface of the plate 12.

FIG. 6 shows a connection diagram of the ultrasonic motor 9 or 11, respectively, with a self-exciting generator 37 driving the motor. The circuit includes a switch for the change of direction 38, which consists of two switches 39 and 40 with poles 41 and 42.

FIG. 7 shows the asymmetrical shape of the acoustic wave generated in the plate 12. Position 43 shows the piezoelectric plate 12 with an excitation electrode 32. Positions 44 and 45 show two pictures of the deformed plate 12 each time-shifted by half an oscillation period. Position 46 shows the path of motion 47 of the material points 48 of the lateral surfaces 13 of the piezoelectric plate 12. Line 49 represents the envelope curve of the path of motion 47.

FIG. 8 shows the electric circuit of the optical module 1 with the electronic control unit 50 and two self-exciting generators 37. The electronic control unit 50 has three control inputs 51, 52, 53. Each of the self-exciting generators 37 is comprised of a power amplifier 54 with a circuit breaker 55 and a control input 56; a circuit breaker 57, the feedback loop 58, a feedback element 59 and the switch 38 for changing the direction.

In each of the self-exciting generators 37 the switch for changing the direction 38 may be embodied in the form of two switches 39 and 40 with poles 41 and 42, wherein pole 41 is connected to the corresponding electrode 32 of the ultrasonic motor (9, 11) and pole 42 via the feedback element 59 and the circuit beaker 55 to the common electrode 34 of the motor. The control input 56 of the circuit breaker 55 is thereby connected via the feedback loop 58 to the feedback element 59, namely at the point where pole 42 is connected to that of the switch for changing the direction 38.

FIG. 9 shows one of the possible modifications of the electric circuit of the self-exciting generator 37. In this modified embodiment the power amplifier 54 is comprised of a constant-current source 60 of the circuit breaker 55 embodied as a transistor reversing switch, the control input 56 of which is connected via the electronic switch 57 to a driver 61. The feedback loop 58 is a filter—a phase shifter. The feedback element 59 consists of a shunt resistor 62 and a capacitor 63. The switch 38 for changing the direction consists of the two transistor switches 39 and 40 with control inputs 64 and 65.

FIG. 10 shows the electric circuit of the optical module 1 with a self-exciting generator, 37 and the electronic control unit 50. In this modification, the switch for changing the direction is comprised of four two-pole transistor switches 38, 40 and 66, 67 with control inputs 68 and 69. These switches are connected to the motors 9 and 11.

In the optical module as proposed, at least one of the optical lens groups 2, 4 may be connected mechanically to its position sensor 21 for the position determination with respect to the photoelectric imaging sensor 6. The linear slide potentiometers indicated in FIGS. 1 and 11 may be used as position sensor 21. The base part of the potentiometer 22 or 24 is thereby fixed on the casing 18 and the potentiometer pickoff 23, 25 on the carrier 8, 10, i.e. they are mechanically connected to the mobile motor part and the corresponding optical lens group. The position sensor 21 embodied as potentiometer and illustrated in FIG. 11 has three electrical outputs 70, 71 and 72.

FIG. 12 shows a piezoelectric resistance pick-up 73. It consists of a semiconductor tensosensor 74, which is connected to a displacement-force converter 75 the mobile end 76 of which acts on a cam 77 located on the mobile element 16 of the ultrasonic motor 9 or 11. The semiconductor tensosensor 74 has two electrical outputs 78 and 79. It may be embodied in the form of a thin germanium rod bonded to the converter 75.

FIG. 13 shows an electric circuit of the module 1, wherein the electronic control unit 50 comprises a computing unit 80 for the relative position determination of the optical lens groups 2 and 4, the information outputs 81 of which are connected to the control inputs 51, 52, 53 of both or one of the self-exciting generators 37.

FIG. 14 shows the electric circuit of module 1, wherein the electronic control unit 50 comprises a digital control unit 82 for the positioning of the optical lens groups, including a zoom input 83 and a focus input 84 the outputs 81 of which are connected to the control inputs 51, 52, 53 of both or one of the self-exciting generators 37.

In FIG. 15 positions 85 and 86 show examples of the arrangement of the optical module 1 in a casing 87 of the apparatus, wherein the optical axis 7 extends in parallel to the surface 88 of one front side.

Upon switching on the optical module 1 an alternating voltage signal is supplied from the electronic control unit 50 (FIG. 6, switch 39 closed, switch 40 open) to the excitation electrode 32 of the piezoelectric plate 12 of the ultrasonic motor 9 or 11 (FIGS. 4, 5), the frequency of which is equal to the working frequency of the motor. This voltage excites the ultrasonic motor 9 or 11 so that the mobile element 15 experiences a movement.

The ultrasonic motor operates as follows. The voltage supplied to the ultrasonic motor 9 or 11, respectively, excites an acoustic vibration in plate 12, at which an asymmetrical acoustic standing wave is formed in plate 12.

The drawings in FIG. 7 explain the shape of these waves. Positions 44 and 45 in FIG. 7 show two examples of deformed plates 12. The illustrations show a shift by half a period. Position 46 shows the path of motion 47 of the material points 48 on the lateral surface 13 of the plate 12, wherein lens 49 represents the connecting line 49 of the path of motion 47. The path of motion 47 and the form of the connecting line 49 show that the excited standing wave is asymmetrical with respect to the axis of symmetry 33 which extends centrally through the larger side of plate 12. The occurring asymmetry is caused by the path of motion 47 having a prevailing inclination away from the electrode 32.

This occurring inclination entails that a force acts on the friction elements 14 pressed against the lateral surfaces 13 of plate 12, namely in the direction of the electrode 12 as indicated in FIG. 12 by an arrow. The force occurring thereby is proportional to the applied voltage. If the applied voltage is sufficiently high, the friction elements 14 move along the lateral surfaces 13 of plate 12. Together with the friction elements also the mobile element 16 with the optical lens group 2 and 4 mounted on the same is moving.

By opening switch 39 and closing switch 40 the electrical voltage is supplied to the second electrode 32 of plate 12. This causes a reversed motion, whereupon the element 16 starts to move in the reverse direction.

The maximum possible distance z, by which the optical lens group 2 can be displaced, is limited by height h (FIG. 4) of the piezoelectric plate 12 and amounts to approximately half the height of the plate. This distance defines the maximum and minimum focal length of module 1. Distance f, by which the optical lens group 4 can be displaced, is defined by the focusing of module 1 with respect to the object and amounts to approximately 0.1 z.

In the modifications of the optical module 1 shown in FIG. 1, 2 ultrasonic motors (FIG. 4) are employed, the lateral surfaces 13 of which comprise guiding grooves 17. The grooves 17 are embodied such that the motion of the friction elements 14 is linear and alongside of the lateral surfaces 13. The linearity of the path of motion is determined by the production accuracy of the guiding grooves 17. With a displacement of z=5 mm the deviation of the path of motion q from the linearity may be +/−0.005 mm.

The arrangement of the piezoelectric plates 12 in a U-shaped (or L-shaped) casing 18 allows an exact coincidence of the optical axes 3 and 5 relative to each other. With a displacement of the optical lens groups 2 and 4 within the range of the focal length alteration of the optical module 1 it is, thus, possible to maintain the coincidence of their optical axes 3 and 5. The deviation from the exact coincidence of the optical axes is arctg q/s.

FIG. 3 shows a modification of the optical module 1, comprising rod-shaped guides 28 which ensure that the coincidence of the optical axes 3 and 5 of the optical lens groups 2 and 4 is maintained. Such a construction of the optical module has a slightly smaller accuracy in view of the coincidence of the optical axes 3 and 5. However, the advantage of the construction resides in the lower production costs because no guiding grooves have to be manufactured.

The electronic control unit 50 of the optical module 1 may consist of the two self-exciting generators 37 which are provided for the simultaneous, independent excitation of the motors 9, 11. The two generators 37 are connected to the motors 9 and 11, which define the excitation frequency of the generators on the basis of their working resonance frequency. The switch 38 for changing the direction, which is comprised of switches 39 and 40, is connected to the feedback element 59 in such a way that the current flowing through the piezoelectric plate 12 generates a feedback signal at the feedback element. This voltage is supplied via the feedback loop 58 to the control input 56 of the circuit breaker 55.

FIG. 9 shows the specific electric circuit of the self-exciting generator 37. In the circuit the feedback 59 is formed of the shunt resistor 62 and the capacitor 63. The value of the reactance of the capacitor 63 at the working frequency is chosen to be significantly smaller than that of the resistance. Therefore, the feedback signal occurring at the feedback element 59 is phase-shifted by approximately 90° relative to the current flowing through the piezoelectric plate 12.

From the feedback voltage the first harmonic is formed and amplified. The frequency of the harmonic corresponds to the working frequency of the ultrasonic motors 9 and 11. The voltage is amplified such that the feedback factor in the open state of the self-excited generator is greater than 1. By the feedback loop 58 the feedback voltage is shifted such that the common phase shift in the open state of the self-exciting generator is equal to zero at the working frequency of the ultrasonic motor. If the circuit breaker 57 is closed, the self-exciting generator 37 starts independently to oscillate on the frequency which is determined by the part of the plate 12 the electrode 32 of which is connected via the reversing switch 38 to the feedback element 59. An asymmetrical standing wave is formed in the plate 12—see FIG. 7. Upon the starting self-excitation of generator 37 the mobile element 16 begins to move away from the connected electrode. If the circuit breaker is 57 opened, this leads to the termination of the self-excitation and to the stop of the motion of the mobile element 16.

By applying a control voltage to the inputs 51, 52, 53 it is possible to independently switch the corresponding ultrasonic motors on and off, respectively, and to independently alter the direction of motion of the mobile element 16 of the corresponding ultrasonic motor 9, 11.

FIG. 10 shows the electric circuit of the optical module 1, in which the electronic control unit 50 is formed of the self-exciting generator 37. If a switch of the self-exciting generator 37 is closed, the corresponding electrode 32 of the corresponding motor 9 or 11 is activated. In this modified embodiment of module 1 only an alternating operation of the motors 9 and 11 is possible.

The optical module according to the embodiment may consist of a position sensor 20, a lens group 2 and a position sensor 21 for the lens group 4 (FIG. 1). The sensors may be embodied as slide potentiometers (FIG. 11) the pickoffs 23 and 25 of which determine the position of the optical lens groups 2 and 4 with respect to the photoelectric imaging sensor 6. If a direct voltage is applied to the output 70 of the sensor 20 or 21 an electric voltage appears at the output 71 the intensity of which depends directly on the position of the sensor 20 and 21.

The position sensor (see FIG. 12) can also be embodied as a piezoelectric resistance pick-up 73. Such a sensor is formed of a displacement-force converter 75. Upon a displacement of the mobile element 16 the cam 77 acts on the mobile end 76 of the converter so that the end thereof moves vertically to the lateral surface 13 of plate 12 in the manner indicated by arrows in FIG. 12. Such an arrangement causes a compression or expansion, respectively, of the semiconductor tensosensor 74, resulting in an extension or shortening, respectively, of the active resistor.

By coupling the outputs 78, 79 of the semiconductor tensosensor 74 into one of the branches of the resistance bridge it is possible to exactly determine from the unbalance of the bridge the position of the lens groups 2 and 4 in relation to the photoelectric imaging sensor 6.

The use of the sensors 20, 21 and 73 in the optical module 1 realized in accordance with the embodiment allows an exact positioning of the optical lens groups 2 and 4 in the required position.

By means of the electric circuit according to a possible embodiment of the optical module 1 as shown in FIG. 13 the lens group 2 with the ultrasonic motor 9 and the video search device (not indicated in the illustration) is positioned in the position of the desired object enlargement. The sensor 20 generates a signal at its output 71, which corresponds to the position of the lens group 2. The computing unit 80 determines from the signal the required position for the lens group 4. The ultrasonic motor 11 brings the lens group 2 into this position.

As was already mentioned above, also other embodiments for controlling the optical module 1 are possible. The electronic control unit 50 can consist, for example, of a digital control unit 82. A signal of the control unit for the object enlargement by the module 1 is applied at the zoom input 83 of the electronic control unit 50. This signal controls the motor 9 moving the zoom lens group 2. A signal controlling the motor 11 is applied at the zoom input 84. This motor moves the focusing lens group 4. Both signals are generated by a processor (not shown in the drawing) which evaluates the information supplied by the photoelectric imaging sensor of module 1.

The optical module as proposed represents a compact optical module with extremely small dimensions and integrated, directly driven ultrasonic linear motors. For example, the dimensions of the optical module with a zoom lens group and a travel distance of 6 mm are 13×7×12 mm. The module can be disposed in the casings of apparatus in such a way that its optical axis 7 extends vertically to the surface of the front side of the apparatus. If a further reduction of the dimensions of the apparatus is desired, the module as proposed can be arranged in the apparatus in such a way that its optical axis extends in parallel to the surface 88 of its front side, as is shown by positions 85 and 86 of FIG. 15.

The optical module as proposed allows a high positioning accuracy for the optical lens group and, therefore, a high resolution of the objective. The use of directly driven ultrasonic linear motors permits short adjusting times of the optical lens groups. For example, the adjusting time of a prototype of the module was 0.05 seconds. Because of the simple construction the production costs are low, and the module can be employed in inexpensive consumer electronic products, such as in mobile phones. During the operation no acoustic operating noises will occur, which is a benefit for the use thereof.

### REFERENCE NUMERALS

1 optical module
2 zoom lens group
3 optical axis of optical lens group 2
4 focusing optical lens group 4
5 optical axis of optical lens group 4
6 photoelectric imaging sensor 6
7 optical axis of module 1
8 carrier of optical lens group 2
9 first ultrasonic motor
10 carrier of optical lens group 4
11 second ultrasonic motor
12 piezoelectric plate
13 lateral surface of piezoelectric plate 12
14 friction elements
15 elastic press-on elements
16 mobile elements
17 guiding grooves
18 U-shaped casing
19 sound-absorbing back-up
20 position sensor for lens group 2
21 position sensor for lens group 4
22 stationary part of sensor 20
23 mobile part of sensor 20
24 stationary part of sensor 21
25 mobile part of sensor 21
26 L-shaped casing
27 flat surface of side 13
28 guide rods
29 sound-absorbing casing
30 front side of plate 12
31 the larger sides of plate 12
32 excitation electrodes
33 axis of symmetry of side 31
34 common electrode
35 friction element 14 as hemisphere
36 friction surface
37 self-exciting generator
38 reversing switch
39 switch
40 switch
41 pole of circuit breaker
42 pole of circuit breaker
43 plate 12 with an electrode 32
44 oscillation images of plate 12
45 oscillation images of plate 12
46 image of path of motion 47
47 path of motion
48 material points on the surface of lateral surface 13
49 envelope curve of path of motion 47
50 electronic control unit
51 input of electronic control unit 50
52 input of electronic control unit 50
53 input of electronic control unit 50
54 power amplifier
55 circuit breaker of self-exciting generator 37
56 control input of power switch for circuit breaker 55
57 circuit breaker of self-exciting generator 37
58 feedback loop
59 feedback element
60 constant-current source
61 driver
62 resistor as feedback element
63 capacitor as feedback element
64 control input for switch 39
65 control input for switch 40
66 switch
67 switch
68 control input for switch 66
69 control input for switch 67
70, 71, 72 electrical outputs of position sensors 20, 21
73 piezoelectric resistance pick-up
74 semiconductor tensosensor
75 displacement-force converter
76 mobile end of displacement-force converter
77 cam
78, 79 outputs of semiconductor tensosensor
80 computing unit for relative position determination
81 information output
82 digital control unit
83 zoom input for digital control unit 82
84 focus input for digital control unit 82
85, 86 positions with examples for the arrangement of module 1 in casing 87
87 casing
88 surface of the front side of the apparatus

1. Objective module comprising an optical zoom lens group and a focusing optical lens group, the combined optical axes of which form the optical axis of the objective, and comprising an electric drive for both lens groups,
characterized in that
the electric drive, of the lens groups is embodied in the form of two linear ultrasonic motors, wherein each of the two ultrasonic motors is realized in the form of a piezoelectric plate having two friction elements which are pressed against the opposite front sides and form the mobile elements of the ultrasonic motors together with the press-on elements, wherein each of the mobile elements is elastically connected to the corresponding lens group and the ultrasonic motors are arranged in such a way that the direction of motion of the mobile elements extends substantially in parallel to the optical axis of the optical module.

2. Objective module according to claim 1,
characterized in that
the front sides of the piezoelectric plates comprise guiding grooves which fix the mobile elements in such a way that the optical axes of the aforementioned lens groups are in coincidence upon their displacement within the focal range of the optical module.

3. Objective module according to claim 1,
characterized in that
the front sides of the piezoelectric plates are realized as flat surfaces, wherein each of the optical lens groups is provided with one or two guiding elements which provide that the optical axes of the optical lens groups are in coincidence upon their displacement within the focal range of the optical module.

4. Objective module according to claim 1,
characterized in that
the ultrasonic motors are arranged on opposite sides of the optical axis of the optical module.

5. Objective module according to claim 1,
characterized in that
the ultrasonic motors are arranged on the same side with respect to the optical axis of the optical module.

6. Objective module according to claim 1,
characterized by
an integrated electronic control unit for the electric drive.

7. Objective module according to claim 6,
characterized in that
the electronic control unit comprises two self-exciting generators for the simultaneous, independent excitation of each motor, wherein the working frequency of each of the self-exciting generators is predetermined by the working resonance frequency of the motor connected to the same and each of the self-exciting generators is provided with a power amplifier, a feedback element with a feedback loop and a switch for changing the direction of the mobile elements.

8. Objective module according to claim 6,
characterized in that
the electronic control unit comprises one self-exciting generator for the independent, alternate excitation of two motors connected to it, which is provided with a power amplifier, a feedback element and a switch for changing the direction of the mobile elements.

9. Objective module according to claim 7,
characterized in that
the or each switch for changing directions is embodied as a two-pole switch, wherein one pole is connected to the corresponding excitation electrode of the respective ultrasonic motor and the other pole is connected via the feedback element and the power switch of a power amplifier to the common motor electrode, wherein the control input of the power switch is connected via a feedback loop to the feedback element, namely at the point where it is connected to the pole of the switch for changing directions.

10. Objective module according to claim 6,
characterized in that
at least one optical lens group is mechanically coupled to a position sensor the output of which is connected to the electronic control unit.

11. Objective module according to claim 10,
characterized in that
the position sensor for determining the position of the optical lens group is embodied as a linear potentiometer the pickoff of which is mechanically connected to the mobile element of the ultrasonic motor or to an optical lens group.

12. Objective module according to claim 10,
characterized in that
the position sensor for determining the position of the optical lens group is embodied as a semiconductor tensosensor coupled to an elastic displacement-force converter, which is mechanically connected to the mobile element of the ultrasonic motor or to an optical lens group.

13. Objective module according to claim 10,
characterized in that
the electronic control unit is provided with a computing unit for determining the relative position of the lens groups, to which the position sensors of the lens groups are connected and the outputs of which are connected to the control inputs of one or both self-exciting generators.

14. Objective module according to claim 7,
characterized in that
the electronic control unit is provided with a digital control unit for positioning the optical lens groups, which has a zoom input with a focus input and the outputs of which are connected to the control inputs of one or both self-exciting generators.

15. Objective module according to claim 1,
characterized by
a photoelectric imaging sensor for converting the optical image into an electric signal.

16. Objective module according to claim 2,
characterized in that
the ultrasonic motors are arranged on opposite sides of the optical axis of the optical module.

17. Objective module according to claim 3,
characterized in that
the ultrasonic motors are arranged on opposite sides of the optical axis of the optical module.

18. Objective module according to claim 2,
characterized in that
the ultrasonic motors are arranged on the same side with respect to the optical axis of the optical module.

19. Objective module according to claim 3,
characterized in that
the ultrasonic motors are arranged on the same side with respect to the optical axis of the optical module.

20. Objective module according to claim 2,
characterized by
an integrated electronic control unit for the electric drive.
